(19) United States
(12) Patent Application Publication
(10) Pub. No.: US 2021/0129331 A1
(43) Pub. Date: May 6, 2021

(54) CONTROL METHOD, CONTROL APPARATUS, ROBOT APPARATUS, METHOD OF MANUFACTURING AN ARTICLE, MOTION PROGRAM CREATION METHOD, MOTION PROGRAM CREATION APPARATUS, DISPLAY APPARATUS, AND CONTROL PROGRAM RECORDING MEDIUM

(71) Applicant: CANON KABUSHIKI KAISHA, Tokyo (JP)

(72) Inventor: Takemi Tokuoka, Tokyo (JP)

(21) Appl. No.: 17/061,240

(22) Filed: Oct. 1, 2020

(30) Foreign Application Priority Data
Oct. 30, 2019 (JP) 2019-197997

(51) Int. Cl. B25J 9/16; G05B 19/4155

(52) U.S. Cl. CPC B25J 9/1664; G05B 2219/40388; G05B 19/4155

(57) ABSTRACT

A control method of controlling a robot apparatus based on a plurality of teaching points includes setting a motion condition for each of the plurality of teaching points, selecting a teaching point at which the motion condition is to be changed, from among the plurality of teaching points, and obtaining a new teaching point that causes a pose of the robot apparatus to change at the selected teaching point.

### BACKGROUND

### Field of the Disclosure

The present disclosure relates to methods of controlling robot apparatuses.

### Description of the Related Art

In recent years, tasks such as assembly and inspection of products in a production line of a factory have been automated with robot devices. There are many types of robot devices used, and one of the most widely used types of robot devices is a robot device equipped with a rotatable joint. To operate such a robot device, a teaching task is carried out. The teaching task is to specify an angle for each of all the joints of a robot device. An operator sets a work point at which the hand of the robot device is to be located and sets a pose of the hand of the robot device at each work point in accordance with work details of the robot device. Thus, the angles of the joints are determined. To operate a robot device continuously at two or more work points, a teaching task is carried out for each of the work points to create a motion program that describes a movement sequence between the work points.

However, some tasks on a production line have tens to hundreds of work points. Then, there may be no constraints on movement sequences between these work points or on poses of the hand of a robot device at each work point. For such a task, an operator often determines a movement sequence between the work points and a pose of the hand of the robot device at each work point based on the operator's intuition and knacks in the process design. However, the determination of a sequence and respective poses for tens to hundreds of work points is a complicated work through trial and error. As a result, a sequence and poses determined above may often present an inefficient motion program that causes the robot device to take a longer time to operate.

As one approach for solving such an issue, Japanese Patent Application Laid-Open No. 2017-140684 discusses a robot programming device capable of determining a sequence of work points by using the solution of traveling salesman problems so that a robot device can move in appropriate order independently of the operator's skill level. In addition, Japanese Patent Application Laid-Open No. 2003-103481 discusses a pose optimization method of optimizing robot device hand poses at individual work points so that the robot device can work in an appropriate pose at each work point without depending on the operator's skill level.

However, the techniques discussed in Japanese Patent Application Laid-Open Nos. 2017-140684 and 2003-103481 have the following issues. For example, assuming a process with 15 work points of which each can have five poses, the technique discussed in Japanese Patent Application Laid-Open No. 2017-140684 enables the sequence of the 15 work points to be optimized. However, to optimize the poses as well using the technique discussed in Japanese Patent Application Laid-Open No. 2003-103481, it is necessary to consider a large number of pose combinations every changing the sequence of the work points. Even if the calculation of a motion program for one combination takes a short time, a huge amount of time is necessary.

### SUMMARY

Embodiments of the present disclosure are directed, in view of the above-mentioned issue, to the creation of a motion program taking a shortened motion time while considering both the sequence and the poses, with a calculation time that is shorter than those with the conventional techniques.

According to embodiments of the present disclosure, a control method of controlling a robot apparatus based on a plurality of teaching points includes setting a motion condition for each of the plurality of teaching points, selecting a teaching point at which the motion condition is to be changed, from among the plurality of teaching points, and obtaining a new teaching point that causes a pose of the robot apparatus to change at the selected teaching point.

Further features of the present disclosure will become apparent from the following description of exemplary embodiments with reference to the attached drawings.

### BRIEF DESCRIPTION OF THE DRAWINGS

FIG. 1 is a schematic diagram illustrating a robot system according to a first exemplary embodiment.

FIG. 2 is a block diagram of the robot system according to the first exemplary embodiment.

FIG. 3 is a schematic diagram of a simulation device according to the first exemplary embodiment.

FIG. 4 is a flowchart illustrating a processing procedure of a method of creating a motion program according to the first exemplary embodiment.

FIG. 5 is a display example of a display according to the first exemplary embodiment.

FIGS. 6A and 6B are schematic diagrams of teaching point candidates according to the first exemplary embodiment.

FIG. 7 is a schematic diagram illustrating a motion based on the motion program according to the first exemplary embodiment.

FIG. 8 is a schematic diagram illustrating a motion based on the motion program according to the first exemplary embodiment.

FIG. 9 is a schematic diagram illustrating a motion based on the motion program according to the first exemplary embodiment.

FIG. 10 is a graph illustrating a relationship between the number of work points and the number of teaching point candidates according to the first exemplary embodiment.

FIG. 11 is a display example of a display according to the first exemplary embodiment.

FIG. 12 is a display example of a display according to the first exemplary embodiment.

FIGS. 13A and 13B are schematic diagrams of teaching point candidates according to a second exemplary embodiment.

### DESCRIPTION OF THE EMBODIMENTS

Exemplary embodiments of the present disclosure will now be described with reference to the accompanying drawings. It should be understood that the exemplary embodiments described below are just examples and, for example, those skilled in the art can appropriately change detailed configurations without departing from the spirit of the present disclosure. In addition, the numerical values employed in the exemplary embodiments are numerical values for reference and do not limit the present disclosure.

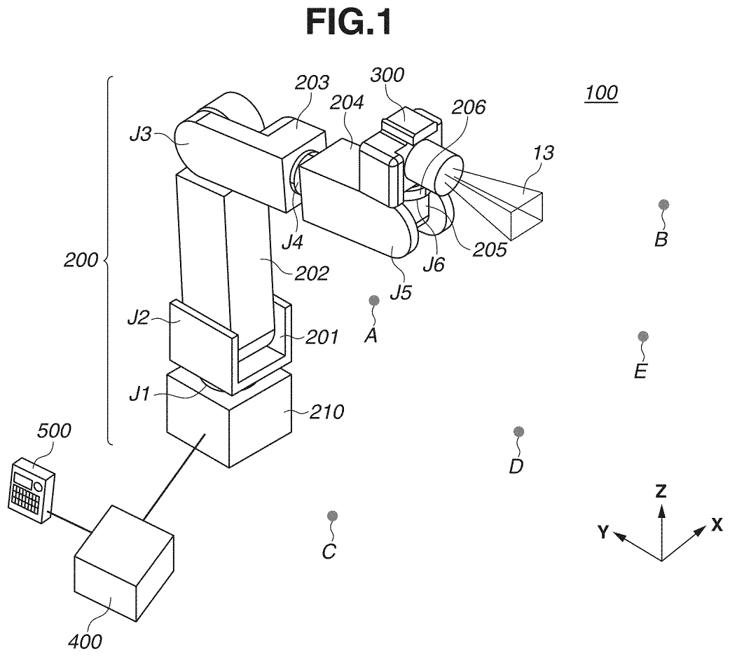

FIG. 1 is a plan view of a robot system 100 according to a first exemplary embodiment as viewed from a certain direction in the XYZ coordinate system. In the following drawings, arrows X, Y, and Z in the drawings indicate the coordinate system of the entire robot system 100. A typical robot system using a robot device may employ a local coordinate system for a robot hand, a finger, or a joint for control purposes, in addition to a world coordinate system for the entire installation environment. In the present exemplary embodiment, the world coordinate system as the coordinate system of the entire robot system 100 is represented by XYZ, and the local coordinate system is represented by xyz.

As illustrated in FIG. 1, the robot system 100 includes an articulated robot arm main body 200, an imaging device 300 mounted on the robot arm main body 200, and a control device 400 that controls the motion of the robot arm main body 200.

The control device 400 is provided with an external input device 500 functioning as a teaching device that transmits teaching data that is data regarding teaching points that are applicable to the robot arm main body 200. The external input device 500, for example, a teaching pendant, is used for an operator to specify a position and orientation of the robot arm main body 200 (strictly speaking, angles of all the joints).

In the present exemplary embodiment, a case will be described where the imaging device 300 is provided at the hand of the robot arm main body 200 as an end effector. However, the present exemplary embodiment is not limited thereto, and the imaging device 300 may be appropriately replaced with a robotic hand, or a robot tool. In the present exemplary embodiment, the hand of the robot arm main body 200 is a portion where the imaging device 300 is provided. The imaging device 300 attached as an end effector is referred to as the hand.

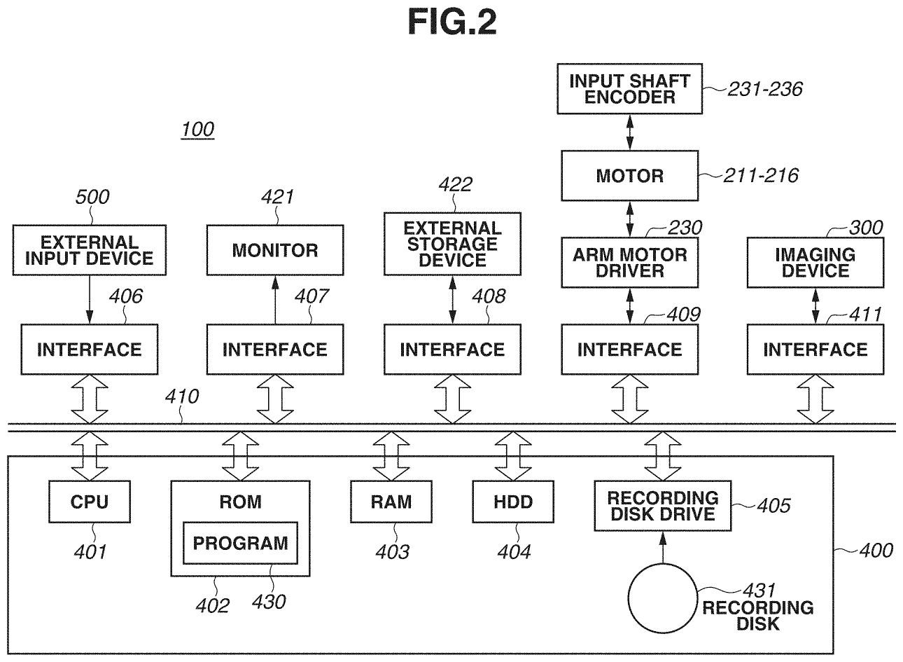

The robot arm main body 200 has a link 201 functioning as the base end of the robot arm main body 200, and the link 201 is provided on a base 210. The imaging device 300 captures an image of a work piece from a position and orientation of the hand of the robot arm main body 200 and is used to control the robot arm main body 200. In addition, the robot arm main body 200 has a plurality of links 201 to 206 connected in series orderly from the base end of the robot arm main body 200 toward the hand. Their links 201 to 206 are rotatable at joints J₁ to J₆, respectively. In addition, the robot arm main body 200 has a plurality (six) of motors 211 to 216 (see FIG. 2) that rotate the joints J₁ to J₆ around the respective rotation axes.

The imaging device 300 is connected to the link 206, and the rotation of the link 206 at the joint J₆ enables the imaging device 300 to be rotated. Then, controlling each value of the joints J₁ to J₆ makes it possible to form poses of the imaging device 300 (specifically, hand) in any three orientations at any three-dimensional positions. The values of the joints J₁ to J₆ that cause poses in any three orientations at these any three-dimensional positions are teaching points.

Then, mounting a robotic hand as an end effector instead of the imaging device 300 makes it possible for the robot arm main body 200 to operate the robotic hand at any position, the robotic hand performing an intended task, for example, a task of manufacturing an article assembled by target objects being pieced together.

The imaging device 300 can capture an image in the quadrangular pyramid area indicated by a field of view 13. An appropriate setting of values of the joints J₁ to J₆ enables the imaging device 300 to be moved to an intended three-dimensional position to capture an image of a target object. In the present exemplary embodiment, target objects are located at points A, B, C, D, and E in FIG. 1, and the imaging device 300 captures the points A, B, C, D, and E.

FIG. 2 is a block diagram illustrating a configuration of the robot system 100 according to the present exemplary embodiment. The control device 400 is configured of a computer and includes a central processing unit (CPU) 401 as a control unit (or processing unit).

Further, the control device 400 includes a read-only memory (ROM) 402, a random-access memory (RAM) 403, and a hard disk drive (HDD) 404 as storage units. In addition, the control device 400 includes a recording disk drive 405 and various interfaces 406 to 409, 411, and 412.

The CPU 401 is connected to the ROM 402, the RAM 403, the HDD 404, the recording disk drive 405, and the interfaces 406 to 409, 411, and 412 via a bus 410. The ROM 402 stores a basic program such as a basic input/output system (BIOS). The RAM 403 is a storage device that temporarily stores various kinds of data such as an arithmetic operation result produced by the CPU 401.

The HDD 404 is a storage device that stores the arithmetic operation result obtained from the CPU 401 and various kinds of data acquired from the outside and that records a program 430 for causing the CPU 401 to execute arithmetic processing. The CPU 401 executes steps of a process of controlling a robot based on the program 430 recorded (or stored) on the HDD 404. The recording disk drive 405 can read out various kinds of data and programs recorded on a recording disk 431.

The external input device 500 is connected to the interface 406. The CPU 401 receives an input from the external input device 500 via the interface 406 and the bus 410.

The interface 409 is connected to an arm motor driver 230. Motors 211 to 216 provided in the respective corresponding joints J₁ to J₆ are respectively equipped with input shaft encoders 231 to 236 as an encoder used to detect rotation angles of the rotation shafts of the motors. The CPU 401 acquires the detection results from the input shaft encoders 231 to 236 via the arm motor driver 230, the interface 409, and the bus 410. In addition, the CPU 401 outputs command value data for each joint to the arm motor driver 230 via the bus 410 and the interface 409 at predetermined time intervals.

The imaging device 300 is connected to the interface 411 and can communicate with the CPU 401 via the bus 410. The CPU 401 acquires an image captured by the imaging device 300 via the bus 410 and the interface 411.

The interface 407 is connected to a monitor 421. Various images are displayed on the monitor 421 under the control of the CPU 401. The interface 408 is configured to be connectable to an external storage device 422, a storage unit such as a rewritable non-volatile memory or an external HDD.

In the present exemplary embodiment, the program 430 is stored on the HDD 404, a computer-readable recording medium, but the present exemplary embodiment is not limited thereto. The program 430 may be recorded in any recording medium as long as it is a computer-readable recording medium.

In one example, the ROM 402, the recording disk 431, or the external storage device 422 may be used as a recording medium used to feed the program 430. Specifically, examples that are usable as the recording medium include a flexible disk, a hard disk, an optical disk, a magneto-optical disk, a compact disc read only memory (CD-ROM), a compact disc-recordable (CD-R), a magnetic tape, a non-volatile memory, and a ROM.

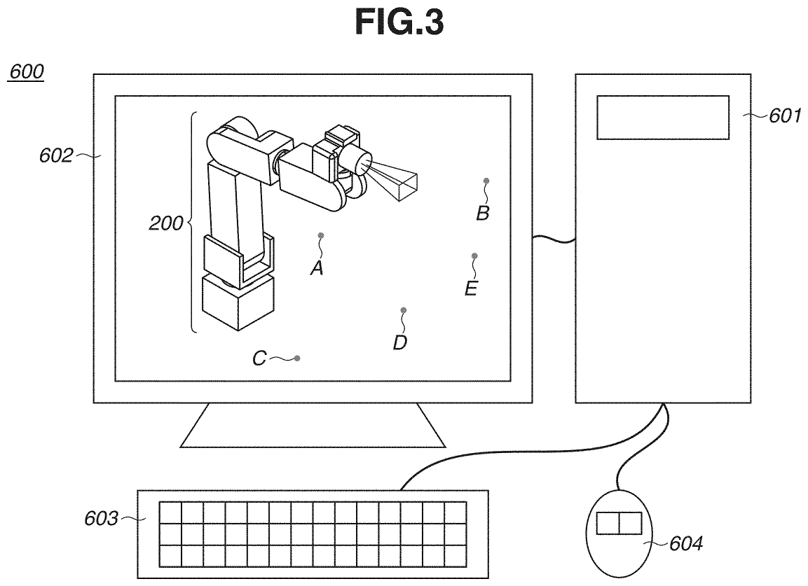

FIG. 3 is a schematic diagram of a simulation device 600 that simulates a motion of the robot arm main body 200. The simulation device 600 is a desktop personal computer that includes an operating system (OS) 601, a display 602, a keyboard 603, and a mouse 604. The OS 601 stores a simulation program created based on computer-aided design (CAD) data of the robot arm main body 200 and information regarding the surrounding environment. The display 602 displays a simulation screen of the robot arm main body 200. The OS 601 also stores information regarding the points A to E to be captured by the imaging device 300 of the robot arm main body 200. The configuration above enables the operator to enter given information using the keyboard 603 and the mouse 604 to create a motion program for the robot arm main body 200 to pass through the points A to E using the simulation device 600. A method of creating a motion program of a circular check task using the simulation device 600 will be described. In the circular check task, the imaging device 300 of the robot arm main body 200 captures the points A, B, C, D, and E in FIG. 1 in no particular sequence and returns to the starting point. Although a motion program is created using the simulation device 600 in the present exemplary embodiment, the motion program may be created using the control device 400 having the simulation program stored therein. This makes it possible for the control device 400 to control the robot arm main body 200 based on the motion program.

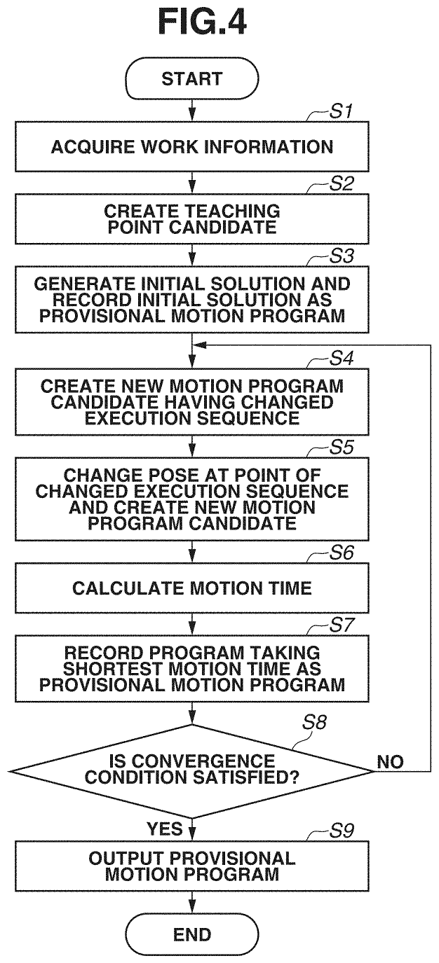

FIG. 4 is a flowchart illustrating a processing procedure of a method of creating a motion program for the robot arm main body 200 according to the present exemplary embodiment of the present disclosure. This flowchart has steps S1 to S9. The details of each processing in steps S1 to S9 are now described with reference to the drawings.

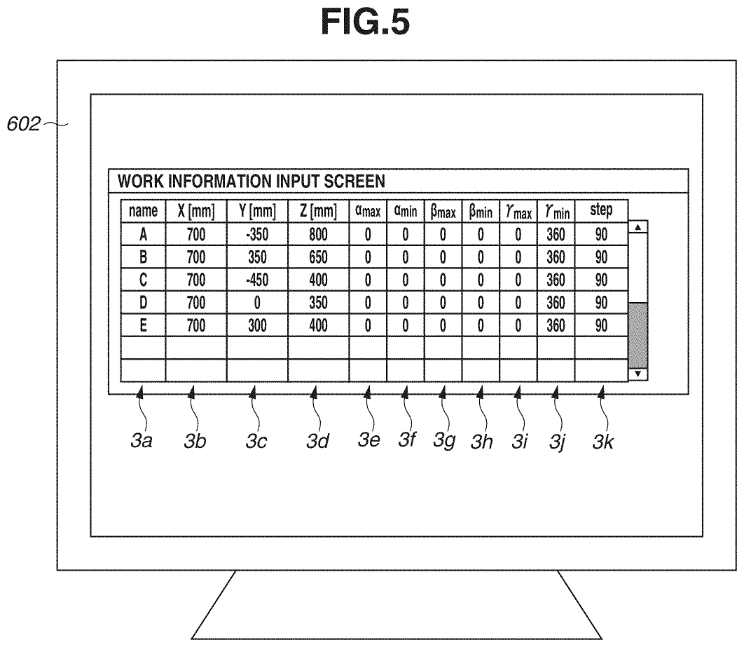

In step S1, an operator acquires work information about the robot arm main body 200. The work information consists of position coordinates of all the work points (points A to E) to be captured by the imaging device 300 as the hand of the robot arm main body 200 and information relating to constraints on a pose of the hand of the robot arm main body 200 at each work point. FIG. 5 illustrates an exemplary diagram in which the display 602 displays a screen for an operator to enter the information regarding work.

In FIG. 5, the operator enters a name optionally assigned by the operator to each work point in the column 3a. In the present exemplary embodiment, the work points are named A, B, C, D, and E as illustrated in FIG. 1. Position information about each work point is input in the columns 3b, 3c, and 3d. In the present exemplary embodiment, the position information is represented by the XYZ orthogonal coordinate system as the world coordinate system. X coordinate values are input in the column 3b, Y coordinate values are input in the column 3c, and Z coordinate values are input in the column 3d.

Information relating to the constraints on a pose of the hand of the robot arm main body 200 at each work point is input in columns 3e, 3f, 3g, 3h, 3i, 3j, and 3k. In the present exemplary embodiment, the poses of the hand of the robot arm main body 200 are represented by Euler angles. Using Euler angles are one of the ways of describing the orientation of a rigid body, and expresses how much the coordinate system fixed to the rigid body is rotated with respect to the reference coordinate system, using three values of α, β, and γ. In a case where the reference coordinate system is (X,Y,Z) and the rigid body coordinate system is (x,y,z), the coordinate system obtained by rotating (X,Y,Z) around the Z-axis by a is expressed as (X′,Y′,Z′). The coordinate system obtained by rotating (X′,Y′,Z′) around the X′ axis by β is expressed as (X″,Y″,Z″). The rigid coordinate system (x,y,z) can be obtained when (X″,Y″,Z″) is rotated around the Z″ axis by γ.

First, the operator enters maximum and minimum values of α, β, and γ from process constraints. Maximum values αₘₐₓ of a are input in the column 3e, minimum values αₘᵢₙ of a are input in the column 3f, maximum values βₘₐₓ of β are input in the column 3g, minimum values βₘᵢₙ of 13 are input in the column 3h, maximum values γₘₐₓ of γ are input in the column 3i, and minimum values γₘᵢₙ of γ are input in the column 3j. The work process targeted in the present exemplary embodiment is for the imaging device 300 as the hand of the robot arm main body 200 to capture each of the points A, B, C, D, and E. There are no constraints on the rotation in the in-plane direction of the quadrangular pyramid base indicated by the field of view 13 in FIG. 1. In this example, the value of the Euler angle γ corresponds to the rotation of the in-plane direction of the quadrangular pyramid bottom surface indicated by the field of view 13. Accordingly, in FIG. 5, the values αₘₐₓ, αₘᵢₙ, βₘₐₓ, and βₘᵢₙ are set to 0° at all the points, and the γ values are set to take a value from 0° to 360°.

Euler angle step increments, “step”, are input in the column 3k. The Euler angle step increments are values used in discretely treating Euler angles that exist infinitely within the range between the minimum value and the maximum value. For example, in FIG. 5, the minimum value of γₘᵢₙ at the point A is 0°, the maximum value is 360°, and the step increment is 90°, so the point A takes any of the values γ=0°, 90°, 180°, and 270°. The operator is able to set any step increment value. In addition, in FIG. 5, although all the points have the same values set with respect to the information regarding constraints on the poses of the hand of the robot arm main body 200, the values may be set differently between work points.

Subsequently, in step S2, teaching point candidates are created based on the information input in step S1. In creating a motion program, all the possible values of the joints J₁ to J₆ of the robot arm main body 200 are created as teaching points. To create a teaching point, the inverse kinematics problem from the position and orientation of a hand of the robot arm main body 200 is solved based on link parameters of the robot arm main body 200, and as the result, respective values for the six joints J₁ to J₆ are uniquely determined. Generally, in the case of a 6-axis vertical articulated robot arm, there can be a plurality of solutions of an inverse kinematics problem for one hand position and hand orientation. However, in the present exemplary embodiment, one inverse kinematics solution is determined for one hand orientation and hand position. In addition, information about values taken by each joint and a motion sequence for each teaching point at each work point are used as a motion condition of the teaching point in the present exemplary embodiment. In other words, the motion condition of the teaching point is a condition that is set at each teaching point. In the present exemplary embodiment, the motion condition consists of a motion sequence and values taken by each joint, but in some cases, speed and acceleration between work points and a change or no change of a teaching point may be set.

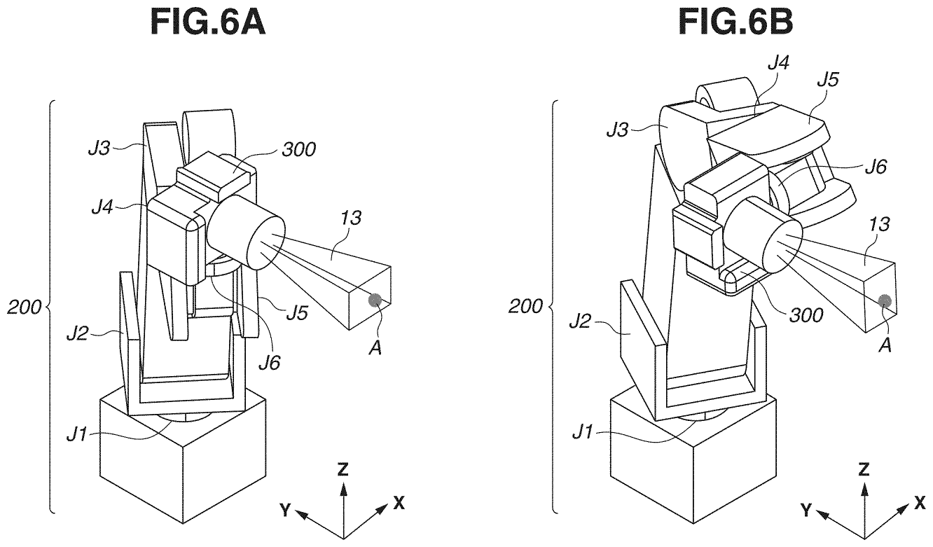

For the point A, from the information of X=700 mm, Y=−350 mm, Z=800 mm, α=0°, and β=0°, which is input in step S1, inverse kinematics problems at γ=0°, 90°, 180°, and 270° are to be solved respectively. In the present exemplary embodiment, there are no inverse kinematic solutions for γ=90° and γ=180° at the point A. FIG. 6A illustrates the robot arm main body 200 capturing the point A at γ=0°, and FIG. 6B illustrates the robot arm main body 200 capturing the point A at γ=270°.

Teaching points different in the hand pose of the robot arm main body 200 at a work point are treated separately from one another. Hence the two teaching points of A are represented as a teaching point A₀ and a teaching point A₂₇₀ using the corresponding values of γ as subscripts. In this example, the respective joints J₁, J₂, J₃, J₄, J₅, and J₆ are the values in Table 1 below.

TABLE 1

| | Teaching point A₀ | Teaching point A₂₇₀ |
|---|---|---|
| J₁ | −40.997° | −27.795° |
| J₂ | 17.613° | 11.264° |
| J₃ | −29.833° | −39.272° |
| J₄ | 0.000° | −76.097° |
| J₅ | −77.780° | 65.688° |
| J₆ | −139.003° | −31.016° |

For other work points, inverse kinematics problems are solved in a similar way, and then the teaching points indicated in Tables 2 to 5 below are obtained. For a simplified description, the illustration of each teaching point is omitted in figures.

TABLE 2

| | Teaching point B₀ | Teaching point B₉₀ |
|---|---|---|
| J₁ | 39.217° | 27.795° |
| J₂ | 14.939° | 4.781° |
| J₃ | −5.138° | −12.481° |
| J₄ | 0.000° | −94.040° |
| J₅ | −99.801° | −62.477° |
| J₆ | 140.783° | 188.689° |

TABLE 3

| | Teaching point C₁₈₀ | Teaching point C₂₇₀ |
|---|---|---|
| J₁ | −46.582° | −37.520° |
| J₂ | 24.860° | 19.192° |
| J₃ | −20.765° | 8.249° |
| J₄ | 0.000° | −109.487° |
| J₅ | 85.905° | 57.281° |
| J₆ | −46.582° | 33.212° |

TABLE 4

| | Teaching point | Teaching point | Teaching point |
|---|---|---|---|
| | D₉₀ | D₁₈₀ | D₂₇₀ |
| J₁ | −17.510° | 1.522° | 17.510° |
| J₂ | 10.307° | −0.515° | 12.341° |
| J₃ | 25.030° | 18.884° | 26.186° |
| J₄ | 79.658° | 0.000° | −78.882° |
| J₅ | 104.208° | 71.631° | 103.614° |
| J₆ | −36.630° | 1.522° | 39.858° |

TABLE 5

| | Teaching point E₉₀ | Teaching point E₁₈₀ |
|---|---|---|
| J₁ | 22.134° | 36.827° |
| J₂ | 8.025° | 12.203° |
| J₃ | 19.719° | −3.283° |
| J₄ | 100.722° | 0.000° |
| J₅ | 70.521° | 81.080° |
| J₆ | −29.589° | 36.827° |

As described above, all the teaching points used in creating a motion program in the present exemplary embodiment are created. Using these points, a motion program of a circular check task is to be created. The circular check task is a task in which the robot arm main body 200 and the imaging device 300 are used to capture the points A, B, C, D, and E in no particular sequence and then returns to the starting point.

The number of circularly checking sequences for circulating work points is equal to the factorial of the number of work points, which means there are 5!=120 ways. The number of combinations of hand poses of the robot arm main body 200 at respective points is equal to the product of the number of hand poses that can be taken at individual points, which means there are 2×2×2×3×2=48 ways. The number of motion program candidates equals the product of the number of ordered combinations and the number of pose combinations, which means there are 120×48=5760 ways. Thus, there exist many motion program candidates. In steps S3 to S8 below, a method of efficiently creating a motion program used to reduce the motion time without verifying the motion time for all of the many motion program candidates will be described.

In step S3, an initial solution is subsequently generated. The initial solution is a motion program, which is used initially as a reference, through which the hand of the robot arm main body 200 moves to each of the work points A, B, C, D, and E one by one to capture any of the work points and returns to the starting point. An initial solution may be a motion program created using an algorithm such as a nearest neighbor algorithm or a motion program initially set by the operator. A nearest neighbor algorithm is an algorithm used to create a motion program in the procedure of setting any one point as a starting point and sequentially tracing points to which the moving object can move in the shortest motion time from the starting point, from among the points to which the moving object has not moved.

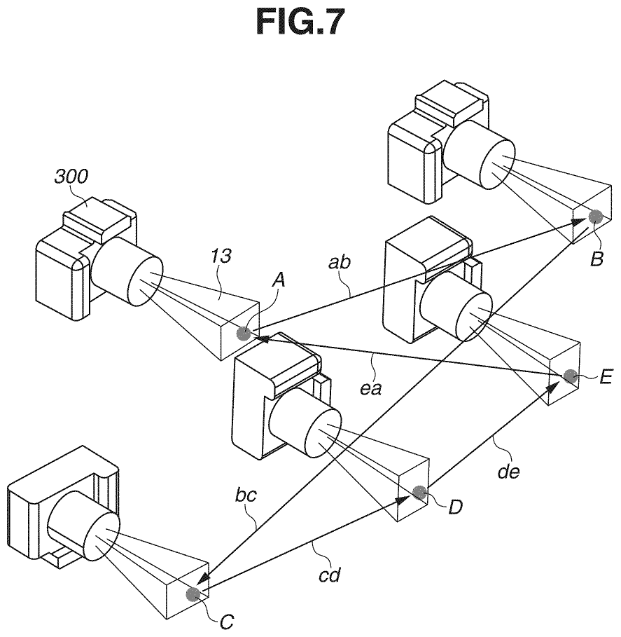

In this example, A₀-B₀-C₁₈₀-D₉₀-E₉₀-A₀ is determined as the initial solution in the sequence entered by the operator in step S1. FIG. 7 schematically illustrates the motion determined as the initial solution only with the imaging device 300 attached to the hand of the robot arm main body 200 and with the field of vision 13 of the imaging device 300. The arrows ab, bc, cd, de, and ea indicate a sequence in which the robot arm main body 200 moves. The motion program determined as the initial solution is now recorded as a provisional motion program.

In step S4, for the provisional motion program created in step S3, a new motion program that is different only in the motion sequence from point A to point E is created without changing the poses. Various possible ways of changing the sequence could be considered, but a method of creating a new motion program with two points switched in the sequence is employed here. In the present exemplary embodiment, only the replacement is made. If the motion time is shortened as a result of the replacement, the modified sequence is maintained. However, if it is not shortened, the modified sequence may be changed back to the original sequence. A new motion program 1 is created in which the sequence of points A and B in the provisional motion program is exchanged.

TABLE 6

| | |
|---|---|
| Provisional motion program | A₀ − B₀ − C₁₈₀ − D₉₀ − E₉₀ − A₀ |
| New motion program 1 | B₀ − A₀ − C₁₈₀ − D₉₀ − E₉₀ − B₀ |

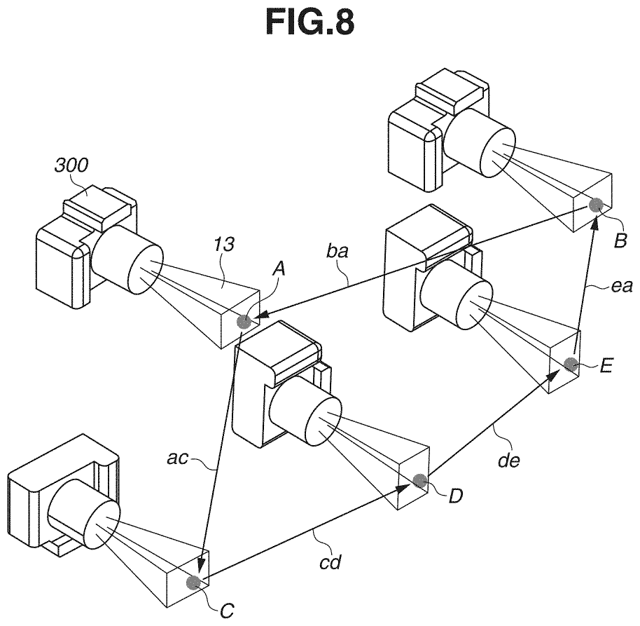

FIG. 8 schematically illustrates the motion of the new motion program 1 created in step S4 only with the imaging device 300 attached to the hand of the robot arm main body 200 and the field of view 13 of the imaging device 300. The arrows ba, ac, cd, de, and ea indicate the sequence in which the robot arm main body 200 moves.

In step S5, in changing from the provisional motion program to the new motion program 1, a new motion program is created in which the poses of the hand of the robot arm main body 200 are changed for the work points for which the motion sequence is changed. In this example, the motion sequence of points A and B is changed in the new motion program 1 compared with the provisional motion program. Next, new motion programs below in which the hand orientations are changed for points A and B are created.

TABLE 7

| | |
|---|---|
| New motion program 2 | B₉₀ − A₀ − C₁₈₀ − D₉₀ − E₉₀ − B₉₀ |
| New motion program 3 | B₉₀ − A₂₇₀ − C₁₈₀ − D₉₀ − E₉₀ − B₉₀ |
| New motion program 4 | B₀ − A₂₇₀ − C₁₈₀ − D₉₀ − E₉₀ − B₀ |

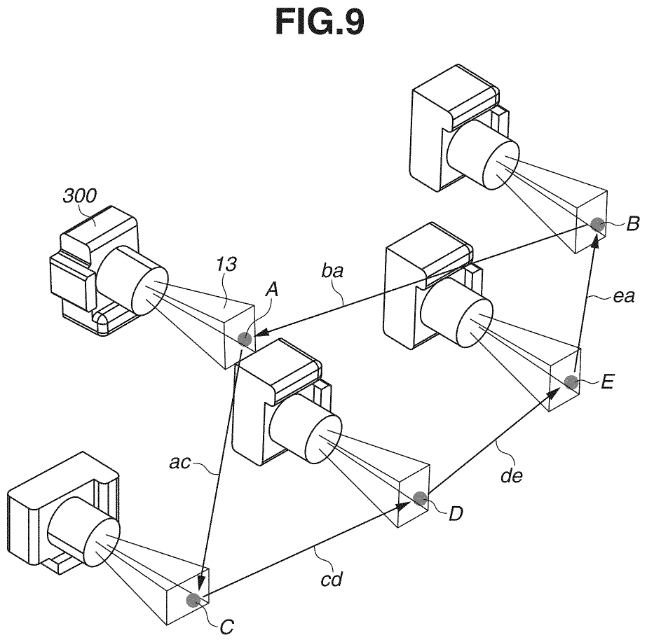

FIG. 9 schematically illustrates the motion of the new motion program 3 in which the orientations of the hand of the robot arm main body 200 at points A and B are changed compared with the new motion program 1, only with the imaging device 300 and the field of view 13 of the imaging device 300. The arrows ba, ac, cd, de, and ea indicate the sequence in which the robot arm main body 200 moves. In FIG. 9, the imaging device 300 is rotated in predetermined directions at points A and B from FIG. 8.

In this example, if verifications are conducted with the poses of the hand at all the points changed, the creation of new motion programs for respective changes of the poses of the hand at the points C, D, and E is necessary. However, the influence of a change of the hand pose at each point on the motion time depends on how much the hand poses at a teaching point and at the next teaching point are changed. In other words, changing poses of the hand at teaching points for which the motion sequence is unchanged is more likely to increase the motion time. Therefore it is unlikely that the change of poses at teaching points for which the motion sequence is unchanged will reduce the motion time significantly. Thus, the verification regarding the change of the poses of the teaching points for which the motion sequence is unchanged is omitted. This makes it possible to efficiently search for a motion program with a shortened motion time.

In step S6, the motion time is calculated for the provisional motion program and each new motion program created in steps S4 and S5. The motion time is calculated by performing trajectory calculation in consideration of the dynamics of the robot arm main body 200. The trajectory calculation should be performed here under a condition that is as close as possible to the behavior when the robot arm main body 200 is actually moved. Thus, the trajectory calculation method is desirable that controls the speed of each joint and the torque applied to the motor within the mechanical constraints. In addition, it is assumed that the trajectory is generated not to interfere with other peripheral equipment and obstacles such as a work piece. In this example, the motion time values indicated in Table 8 below are calculated.

TABLE 8

| | Motion time [sec] |
|---|---|
| Provisional motion program | 2.43 |
| New motion program 1 | 2.41 |
| New motion program 2 | 2.15 |
| New motion program 3 | 1.72 |
| New motion program 4 | 2.48 |

In this example, the new motion program 3 after the change of the pose illustrated in FIG. 9 takes the shortest motion time and is shorter than the motion time of the provisional motion program before the change of the pose. The result makes it clear that the teaching points A₂₇₀ and B₉₀ are suitable at the work points A and B. On the other hand, the result will be shown below which proves that the omission of the motion programs in step S5 is appropriate. The condition to check motion time is that the teaching points A₂₇₀ and B₉₀ are fixed at points A and B, respectively, and that poses at points C, D, and E are changed. The motion time values of the omitted motion programs are calculated as below.

TABLE 9

| | Motion time [sec] |
|---|---|
| Omitted motion program 1 | 1.9 |
| (B₉₀ − A₂₇₀ − C₁₈₀ − D₉₀ − E₁₈₀ − B₉₀) | |
| Omitted motion program 2 | 1.79 |
| (B₉₀ − A₂₇₀ − C₁₈₀ − D₁₈₀ − E₉₀ − B₉₀) | |
| Omitted motion program 3 | 1.75 |
| (B₉₀ − A₂₇₀ − C₁₈₀ − D₁₈₀ − E₁₈₀ − B₉₀) | |
| Omitted motion program 4 | 2.18 |
| (B₉₀ − A₂₇₀ − C₁₈₀ − D₂₇₀ − E₉₀ − B₉₀) | |
| Omitted motion program 5 | 1.9 |
| (B₉₀ − A₂₇₀ − C₁₈₀ − D₂₇₀ − E₁₈₀ − B₉₀) | |
| Omitted motion program 6 | 2.22 |
| (B₉₀ − A₂₇₀ − C₂₇₀ − D₉₀ − E₉₀ − B₉₀) | |
| Omitted motion program 7 | 2.04 |
| (B₉₀ − A₂₇₀ − C₂₇₀ − D₉₀ − E₁₈₀ − B₉₀) | |
| Omitted motion program 8 | 1.852 |
| (B₉₀ − A₂₇₀ − C₂₇₀ − D₁₈₀ − E₉₀ − B₉₀) | |
| Omitted motion program 9 | 1.81 |
| (B₉₀ − A₂₇₀ − C₂₇₀ − D₁₈₀ − E₁₈₀ − B₉₀) | |
| Omitted motion program 10 | 2.08 |
| (B₉₀ − A₂₇₀ − C₂₇₀ − D₂₇₀ − E₉₀ − B₉₀) | |
| Omitted motion program 11 | 1.8 |
| (B₉₀ − A₂₇₀ − C₂₇₀ − D₂₇₀ − E₁₈₀ − B₉₀) | |

It is found that no other motion time is shorter than the new motion program 3 among the omitted motion programs and it is confirmed that the omission is appropriate. Thus, it is possible to efficiently create a program with a short motion time even in a shortened calculation time.

In step S7, the motion program determined as taking the shortest motion time based on the motion times of the provisional motion program and the new motion programs calculated in step S6 is recorded as a new provisional motion program. In this example, since the new motion program 3 takes 1.72 [sec] of the shortest motion time, the new motion program 3 (B₉₀-A₂₇₀-C₁₈₀-D₉₀-E₉₀-B₉₀) is recorded as the new provisional motion program. With respect to 2.43 [sec] of motion time taken by the provisional motion program, the motion time becomes shorter by 0.71 [sec] (or 29.2%).

In step S8, a convergence condition is to be determined. Any convergence condition is settable. The convergence condition may be the motion time of the provisional motion program, the number of times the motion sequence is changed, or the number of motion programs for which the motion time is calculated. In the present exemplary embodiment, the convergence condition is to change the motion sequence for all the combinations of any two points in step S4.

If the convergence condition is not satisfied in step S8, then the flow branches to NO in step S8 and steps S4 to S7 are repeated. Since the convergence condition in this example is to change the motion sequence for all the combinations of any two points, the motion sequence is verified at each of the ₅C₂=10 combinations.

On the other hand, the pose of the hand for each of the 2×2=4 combinations or the 2×3=6 combinations is verified each time the motion sequence is changed. The number of motion program candidates to be verified in this example is equal to the product of the number of ordered combinations and the number of combinations of poses. Hence, the maximum number is 10×6=60. As mentioned in the description of step S2, there is a total of 5760 motion program candidates. Thus, in this case, it can be found that the number of motion program candidates to be verified is smaller and the search is efficiently performed.

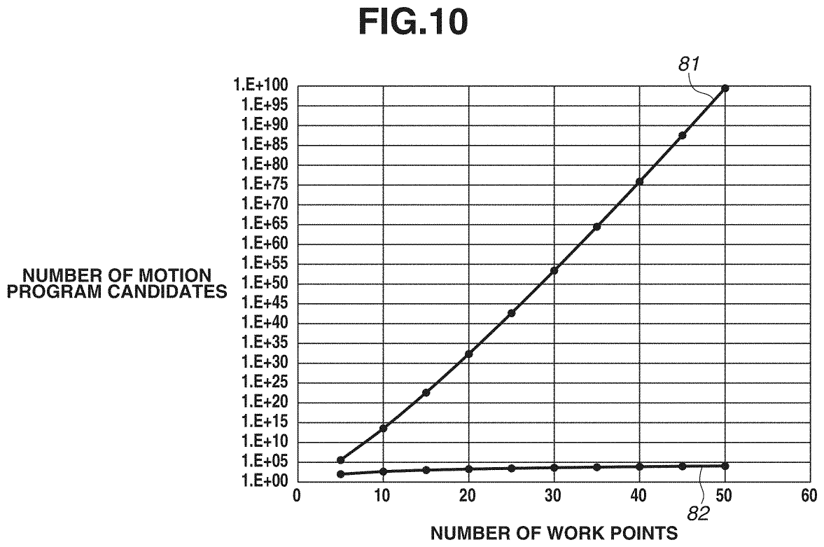

In the present exemplary embodiment, the number of work points and the number of poses of the hand are set to be small for simplification of the description, but the number of work points varies depending on a target process. FIG. 10 is a graph illustrating the relationship between the number of work points and the number of motion program candidates. The horizontal axis is the number of work points and the vertical axis is the number of motion program candidates. The number of all existing motion programs is indicated as a plot 81, and the number of motion program candidates to be verified in a case where the method according to the present exemplary embodiment is used is indicated as a plot 82. The vertical axis is represented in an index format. Moreover, the number of poses that can be taken at each work point is set uniformly to five.

In FIG. 10, the total number of motion program candidates increases explosively as the number of work points increases, while the number of motion program candidates verified by the method according to the present exemplary embodiment remains at a certain level even if the number of the work points increases. If it is assumed that it takes one second to calculate the motion time of one motion program, even if the number of work points is 10, it will take one million years or more to verify all the motion programs. However, the method according to the present exemplary embodiment makes it possible to create the motion program in about 7 minutes in a case where the number of work points is 10 and in about 3 hours even in the case where the number of work points is 50.

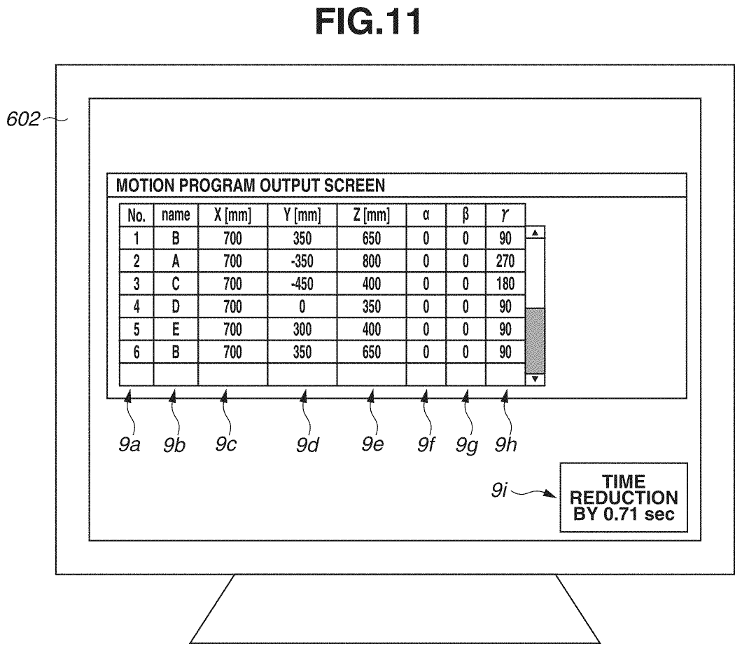

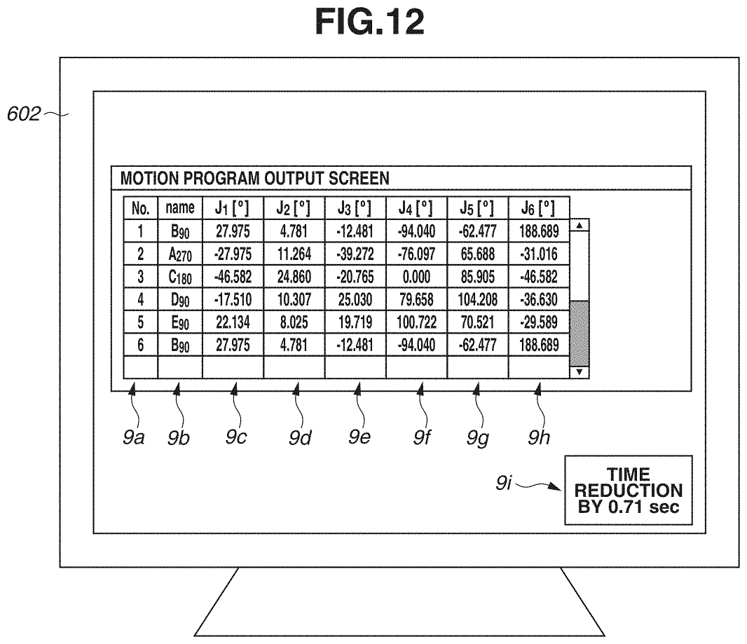

If the convergence condition is satisfied in step S8, then the flow branches to YES in step S8, the creation of motion program candidates is completed, and the current provisional motion program is output to the display 602 as the motion program with the shortest motion time among the verified motion programs in step S9. FIGS. 11 and 12 illustrate examples of a motion program output screen. The displayed motion program is the new motion program 3.

In FIG. 11, the column 9a indicates the sequence of moving to each work point. The column 9b shows the name of each work point in the sequence indicated in the column 9a. The columns 9c, 9d, and 9e show the position coordinates of the respective work points. The position coordinates are values that are the same as those input by the operator in step S1. The X coordinate values are displayed in the column 9c, the Y coordinate values are displayed in the column 9d, and the Z coordinate values are displayed in the column 9e. The columns 9f, 9g, and 9h indicate the poses of the hand of the robot arm main body 200 at each work point with Euler angles. The pose of the hand is represented by a value obtained by selecting an efficient pose according to the present exemplary embodiment based on the constraint condition specified by the operator in step S1. The column 9f shows values of a, the column 9g shows values of β, and the column 9h shows values of γ. How much time is reduced from the provisional motion program that is the motion program determined as the initial solution is represented at 9i.

In FIG. 12, the values that are taken by the joints J₁ to J₆ at each teaching point are displayed. The column 9b indicates the name of each teaching point in the sequence indicated in the column 9a. The columns 9c, 9d, 9e, 9f, 9g, and 9h show possible values for the joints J₁ to J₆. How much time is reduced from the provisional motion program that is the motion program determined as the initial solution is represented at 9i.

Moreover, for the motion program illustrated in FIGS. 11 and 12, the operator may change appropriately the sequence in the column 9a or change the value of each joint at each teaching point illustrated in FIG. 12.

Then, the created motion program that is stored in the recording disk 431 or on the HDD 404 of the control device 400 makes it possible to control the robot arm main body 200 with a shortened motion time.

As described above, in the present exemplary embodiment, the change in the poses at the teaching points for which the motion sequence is changed is verified, and the change in the poses at the teaching points for which the motion sequence is not changed is omitted. The method makes it possible to control the robot arm by creating a motion program taking a short motion time in a practical calculation time while considering both the sequence and the poses.

In the present exemplary embodiment, the method is greatly effective for the work in particular that has no constraints on poses of the hand of the robot arm main body 200 at work points with an explosively increasing number of candidates under consideration for poses of the hand. The method is especially effective for tasks such as visual inspection of target objects using a robot arm as in this example.

Further, in the present exemplary embodiment, the poses are changed at the teaching points for which the motion sequence is changed, but the present exemplary embodiment is not limited thereto. In one example, there is a teaching point to which a motion condition is fixed in some cases depending on the motion of the robot arm main body 200. In the case, the pose of the hand may be changed at a teaching point other than the teaching points to which the motion condition is fixed, and a new teaching point may be set.

A second exemplary embodiment will be described. In the above-described first exemplary embodiment, teaching point candidates are created by solving one inverse kinematics problem for one hand orientation and position. However, with plural combinations of joint angles for one hand position and orientation, teaching point candidates may be created using a plurality of solutions at each work point.

A description is now given of the configurations of hardware and a control system that differ from the first exemplary embodiment. In addition, the parts similar to those of the first exemplary embodiment are regarded as having similar configurations and functions, so that detailed description thereof is omitted.

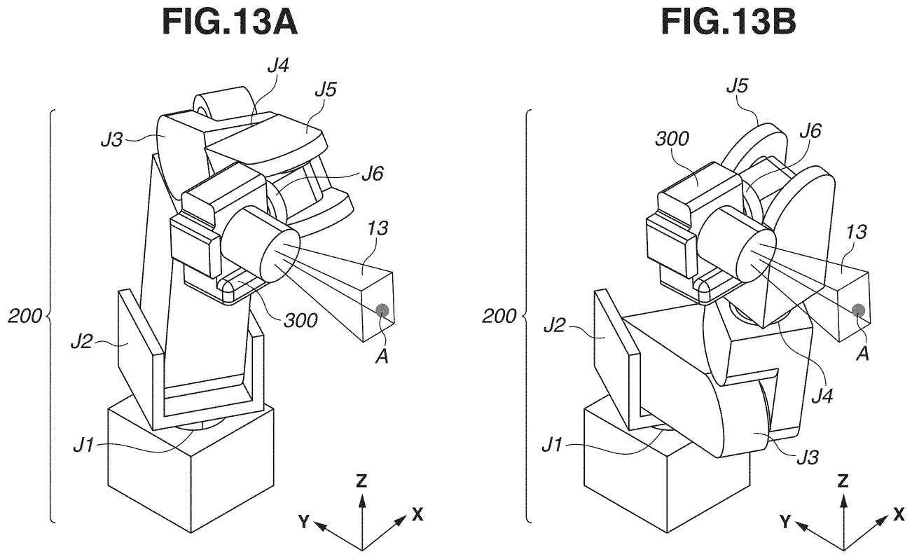

In the present exemplary embodiment, an articulated robot arm with a plurality of combinations of angles of each joint for one hand position and orientation is considered. In one example, the robot arm main body 200 can take not only the state illustrated in FIG. 13A but also the state illustrated in FIG. 13B at the teaching point A₂₇₀ described in the first exemplary embodiment. A 6-axis vertical articulated robot arm as indicated in the robot arm main body 200 takes a maximum of eight combinations of joint angles for one hand position and orientation. However, eight combinations of joint angles are not always found depending on the movable range of each joint and the link length. In the present exemplary embodiment, a teaching point with different inverse kinematics solutions for a hand position and orientation is represented using an integer, i, of 1 to 8 as a teaching point A_{270_i}.

The method of creating a motion program of the robot arm main body 200 according to the present exemplary embodiment is different in step S2 in the flowchart of FIG. 4 from that of the first exemplary embodiment. In step S2, the method of creating a motion program of the robot arm main body 200 according to the present exemplary embodiment involves applying all solutions of inverse kinematics problems that exist for one hand pose to teaching point candidates. In one example, for the teaching point A₂₇₀ used in the first exemplary embodiment, there are four teaching points below found by solving all the existing inverse kinematic problems.

TABLE 10

| | Teaching | Teaching | Teaching | Teaching |
|---|---|---|---|---|
| | point A₂₇₀_{_{—}}₁ | point A₂₇₀_{_{—}}₂ | point A₂₇₀_{_{—}}₃ | point A₂₇₀_{_{—}}₄ |
| J₁ | −27.795° | −27.795° | 152.205° | 152.205° |
| J₂ | 11.264° | 11.264° | −66.820° | −66.820° |
| J₃ | −39.272° | −39.272° | −39.272° | −39.272° |
| J₄ | −76.097° | 103.903° | 116.861° | −63.139° |
| J₅ | 65.688° | 65.688° | 82.574° | −82.574° |
| J₆ | −31.016° | 148.984° | −75.684° | 104.316° |

Similarly, teaching point candidates for all other teaching points A₀, B₀, B₉₀, C₁₈₀, C₂₇₀, D₉₀, D₁₈₀, D₂₇₀, E₉₀, and E₁₈₀ are found by solving all the existing inverse kinematic problems in creating the motion program. The subsequent processing is similar to that of the first exemplary embodiment.

As described above, if the method according to the present exemplary embodiment is employed, a motion program that takes a shorter motion time than that of the first exemplary embodiment can be provided by considering a plurality of inverse kinematics solutions in creating the teaching point candidates.

A third exemplary embodiment will be described. A multi-rotatable joint is not considered in the first and second exemplary embodiments described above, but the present disclosure is also applicable to a robot arm having a multi-rotatable joint.

The configurations of the hardware and the control system will be described below that differ from those of the first exemplary embodiment and the second exemplary embodiment. The parts similar to those of the first exemplary embodiment have similar configurations and features, and so detailed description thereof is omitted.

In the present exemplary embodiment, an articulated robot arm feature is utilized that the hand position and orientation of the robot with a multi-rotatable joint is not changed even if 360 degrees are added to or subtracted from a joint angle.

The method of creating a motion program for the robot arm main body 200 according to the present exemplary embodiment is different in step S2 in the flowchart of FIG. 4 from those of the first and second exemplary embodiments. For the teaching point candidates created in the second exemplary embodiment, the angles of the multi-rotatable joints J₁, J₄, and J₆ are calculated in three cases: no change in angle, a change of +360°, and a change of −360°. However, 360 degrees cannot be always added to or subtracted from the angle of each of all the joints J₁, J₄, and J₆, depending on the movable range and link length of each joint. Multi-rotation information j of J₁, multi-rotation information k of J₄, and multi-rotation information 1 of J₆ are assigned to the teaching point notation used in the second exemplary embodiment, by which a teaching point is expressed as A_{270_i_jkl}. jkl each are expressed by 0 for no change, 1 for a change of +360°, and F for a change of −360°. In one example, for the teaching point A_{270_i}, −360° can be applied to only J₆ of the teaching point A_{270_2}, and the two teaching points below are obtained.

TABLE 11

| | Teaching point A₂₇₀_{_{—}}₂_{_{—}}₀₀₀ | Teaching point A₂₇₀_{_{—}}₂_{_{—}}_{00F} |
|---|---|---|
| J₁ | −27.795° | −27.795° |
| J₂ | 11.264° | 11.264° |
| J₃ | −39.272° | −39.272° |
| J₄ | 103.903° | 103.903° |
| J₅ | 65.688° | −65.688° |
| J₆ | 148.984° | −211.016° |

For other teaching points A_{0_i}, B_{0_i}, B_{90_i}, C_{180_i}, C_{270_i}, D_{90_i}, D_{180_i}, D_{270_i}, E_{90_i}, and E_{180_i}, each teaching point is obtained similarly. In a case where 360 degrees can be added to or subtracted from the angle of any of the joints J₁, J₄, and J₆, it will be included as a new teaching point candidate in creating a motion program. The subsequent processing is similar to that of the first exemplary embodiment.

As described above, if the method according to the present exemplary embodiment is employed, a motion program that takes an even shorter motion time is provided by considering the teaching points of the multi-rotatable joints.

In the various exemplary embodiments described above, it is specifically described that the processing procedures are executed by the simulation device 600. However, a control program of software capable of executing the above-described functions and a recording medium including the program recorded therein may be installed in the control device 400 to execute the processing procedures. In the case, it is possible to use the monitor 421 as the display device and the external input device 500 as the operator's input unit.

Thus, the control program of software capable of executing the functions described above, the recording medium including the program recorded therein, and a communication device are included in the exemplary embodiments of the present disclosure. In one example, the above-described exemplary embodiments may be applicable, as an executable application, to information terminals such as a smartphone.

Further, in the above-described exemplary embodiments, although the computer-readable recording medium is a ROM or a RAM and the control program is stored in the ROM or the RAM, the exemplary embodiments of the present disclosure are not limited to such an example.

The control program used to carry out the present disclosure may be recorded in any recording medium as long as it is a computer-readable recording medium. In one example, an HDD, an external storage device, or a recording disk may be used as the recording medium used to feed the control program.

Further, in the various exemplary embodiments described above, although the robot arm main body 200 is an articulated robot arm having a plurality of joints, the number of joints is not limited thereto. Although the vertical multi-axis configuration is illustrated as a type of robot device, a similar configuration to the above may be employed even with a different type of joint such as a parallel link type.

Further, the various exemplary embodiments described above are applicable to a machine capable of automatically performing a motion such as expansion/contraction, bending/extension, vertical movement, horizontal movement, or turning, or a combined motion thereof, based on information in a storage device provided in the control device.

The present disclosure is not limited to the above-described exemplary embodiments, and many modifications can be made within the technical concept of the present disclosure. In addition, the effects described in the exemplary embodiments of the present disclosure are not limited to those described in the exemplary embodiments.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-197997, filed Oct. 30, 2019, which is hereby incorporated by reference herein in its entirety.

What is claimed is:

1. A control method of controlling a robot apparatus based on a plurality of teaching points, the control method comprising:
setting a motion condition for each of the plurality of teaching points;
selecting a teaching point at which the motion condition is to be changed, from among the plurality of teaching points; and
obtaining a new teaching point that causes a pose of the robot apparatus to change at the selected teaching point.

2. The control method according to claim 1,
wherein the selected teaching point is a teaching point for which a motion sequence for the plurality of teaching points as the motion condition is changed, and
wherein the new teaching point that causes the pose of the robot apparatus to change is obtained at the teaching point for which the motion sequence is changed.

3. The control method according to claim 2, wherein the new teaching point that causes the pose of the robot apparatus to change is not obtained at a teaching point for which the motion sequence is unchanged among the plurality of teaching points.

4. The control method according to claim 2, wherein in a case where the motion sequence is changed and a motion time after the change is shorter than a motion time before the change, the motion sequence remains changed, and in a case where the motion sequence is changed and the motion time after the change is not shorter than the motion time before the change, the changed motion sequence is returned to the motion sequence before the change.

5. The control method according to claim 1, further comprising:
selecting a teaching point other than the teaching point having the fixed motion condition in a case where a teaching point having a fixed motion condition exists among the plurality of teaching points,
wherein the new teaching point that causes the pose of the robot apparatus to change is obtained at the teaching point other than the teaching point having the fixed motion condition.

6. The control method according to claim 5, wherein the motion sequence for the teaching point having the fixed motion condition is not changed.

7. The control method according to claim 5, wherein the new teaching point that causes the pose of the robot apparatus to change is not obtained at the teaching point having the fixed motion condition.

8. The control method according to claim 1, wherein the plurality of teaching points is obtained based on a pose of a predetermined part of the robot apparatus.

9. The control method according to claim 8, wherein the plurality of teaching points is obtained from the pose of the predetermined part using inverse kinematics.

10. The control method according to claim 8,
wherein the robot apparatus has a joint that is multi-rotatable, and
wherein the plurality of teaching points is obtained by adding or subtracting 360 degrees to or from a value set in the joint.

11. The control method according to claim 1, further comprising:
obtaining a teaching point with a shortened motion time of the robot apparatus until a predetermined convergence condition is satisfied.

12. The control method according to claim 1,
wherein the teaching point at which the motion condition is to be changed is selected automatically by a control apparatus, and
wherein the new teaching point that causes the pose of the robot apparatus to change is obtained automatically at the automatically selected teaching point.

13. A non-transitory computer-readable recording medium storing a control program that executes the control method according to claim 1.

14. A control apparatus that controls a robot apparatus based on a plurality of teaching points, the control apparatus configured to perform functions of:
setting a motion condition for each of the plurality of teaching points;
selecting a teaching point at which the motion condition is to be changed, from among the plurality of teaching points; and
obtaining a new teaching point that causes a pose of the robot apparatus to change at the selected teaching point.

15. A robot apparatus comprising a robot arm controlled by the control apparatus according to claim 14.

16. An article manufacturing method comprising manufacturing an article using the robot apparatus according to claim 15.

17. A motion program creation method of creating a motion program that controls motion of a robot apparatus based on a plurality of teaching points, the motion program creation method comprising:
setting a motion condition for each of the plurality of teaching points;
selecting a teaching point at which the motion condition is to be changed, from among the plurality of teaching points; and
obtaining a new teaching point that causes a pose of the robot apparatus to change at the selected teaching point and creating the motion program.

18. A motion program creation apparatus that creates a motion program that controls a motion of a robot apparatus based on a plurality of teaching points, the motion program creation apparatus performing functions of:
setting a motion condition for each of the plurality of teaching points;
selecting a teaching point at which the motion condition is to be changed, from among the plurality of teaching points; and
obtaining a new teaching point that causes a pose of the robot apparatus to change at the selected teaching point and creating the motion program.

19. A display apparatus that displays information regarding a plurality of teaching points set in a robot apparatus, the display apparatus configured to perform functions of:
setting a motion condition for each of the plurality of teaching points;
selecting a teaching point at which the motion condition is to be changed, from among the plurality of teaching points;
obtaining a new teaching point that causes a pose of the robot apparatus to change at the selected teaching point; and
displaying information regarding a teaching point with a changed pose and displaying a motion sequence for the teaching point.

20. The display apparatus according to claim 19, wherein, changes of the information regarding the teaching point after the displayed pose is changed and of the motion sequence for the teaching point are accepted.

21. The display apparatus according to claim 19, wherein the display apparatus displays a degree to which a motion time of the robot apparatus after the pose change is short compared with a motion time of the robot apparatus before the pose change.
